(19) United States
(12) Patent Application Publication
(10) Pub. No.: US 2022/0138567 A1
(43) Pub. Date: May 5, 2022

(54) METHOD FOR PROVIDING A MODEL FOR AT LEAST ONE MACHINE, TRAINING SYSTEM, METHOD FOR SIMULATING AN OPERATION OF A MACHINE, AND SIMULATION SYSTEM

(71) Applicant: Siemens Aktiengesellschaft, 80333 München (DE)

(72) Inventor: PANDU RAHARJA, München (DE)

(73) Assignee: Siemens Aktiengesellschaft, 80333 München (DE)

(21) Appl. No.: 17/431,998

(22) PCT Filed: Feb. 7, 2020
(86) PCT No.: PCT/EP2020/053099

§ 371 Date: Aug. 18, 2021

(30) Foreign Application Priority Data
Feb. 19, 2019 (EP) 19157949.9

(51) Int. Cl. G06N 3/08

(52) U.S. Cl. CPC G06N 3/08

(57) ABSTRACT

In a method for training a model for an electric machine controlled by a control device, a temporal series of measured values that describe an operating variable of the electric machine is received by a training system. An untrained model embodied as an artificial neural network is then trained with the received measured values to produce a trained model. Control variables that describe the control device are determined with the trained model. The training system then receives a temporal series of measured values of a further electric machine that is different from the electric machine and controlled by a further control device. The trained model is then trained further with the computing facility using measured values of the further electric machine to produce a further trained model. The trained model and the further trained model is outputted via a second interface of the training system.

The present invention relates to a method for providing a model for at least one machine, in particular a machine tool.

Furthermore, the present invention relates to a training system, a computer program and a computer-readable (storage) medium. Furthermore, the present invention relates to a method for simulating operation of a machine. Moreover, the present invention relates to a simulation system and an associated computer program.

It is known from the prior art that operation of a machine is controlled by means of a controller or a control device. In particular, in connection with machine tools, for instance CNC machines, complex control devices are used. Control devices of this type, such as are provided in machine tools, comprise controllers of a complex structure, which can have a number of individual controllers or control circuits. If a machine tool of this type is obtained from a manufacturer, there is typically no more detailed information available relating to the control device used therein. When such a machine tool is used, it is often desirable to obtain more accurate information relating to the control device.

Machine learning methods can basically be used in order to reproduce operation of the electric machine which is controlled with the control device. During operation of the machine, it is possible, for instance, to detect a temporal series of measured values, wherein the measured values describe operating variables or an operating state of the machine. In order to be able to derive the behavior of the control device from these measured values or operating variables, the machine learning methods can be used. For instance, linear regression, in which either a linear or a non-linear kernel can be used, can be known here. The training of a corresponding model, by means of which the control device can be mapped, is often very expensive and complicated, particularly with complex control devices, such as are used in machine tools.

EP 0 496 570 A2 discloses a device for identifying a structure and for estimating parameters in a controlled system. A structure of a function which describes a mathematical relationship of inputs into a system in relation to outputs of the system is to be determined therein by means of structure identification means. The parameters associated with the function are then estimated by means of parameter estimation means on the basis of the correspondingly generated function.

US 2002/0072828 A1 describes a method for modeling a non-linear empirical process. A non-linear network model with a number of inputs based on the initial model is to be constructed here on the basis of an initial model. Global behavior of the non-linear network model overall is generally to be compliant with an initial output of the initial model. The non-linear network model is optimized on the basis of empirical inputs, wherein the global behavior is restricted.

DE 10 2006 054 425 A1 discloses a method for determining a value of a model parameter of a reference vehicle model. Here an estimated value of the model parameter is determined repeatedly as a function of a second driving status variable and/or a variable predetermined by a driver by means of an artificial neural network. The artificial neural network is adjusted here on the basis of a learning method.

It is the object of the present invention to point out a solution, as to how operation of a machine, which is controlled by means of a control device, can be modeled easily and at the same time reliably.

This object is achieved according to the invention by a method for providing a model, by a training system, by a computer program product, by a computer-readable (storage) medium, by a method for simulating and by a simulation system and by a further computer program. Advantageous developments of the present invention are specified in the dependent claims.

An Inventive method is used to provide a model for at least one machine, in particular a machine tool. In this regard operation of the machine is controlled by means of a control device. The method comprises receiving a temporal series of measured values, wherein the measured values describe an operating variable of the machine. Furthermore, the method comprises the provision of an untrained model in the form of an artificial neural network. Furthermore, the method includes training the untrained model with the aid of the received measured values and the determination of derived control variables, which describe the control device, by means of the trained model.

A temporal series of measured values of a further machine, the operation of which is controlled with a further control device, is received. Moreover, the trained model is preferably extended, in other words further trained, with the aid of the measured values of the further machine by means of transfer learning. Within the field of machine learning, what is known as transfer learning is essentially known. In this regard a model, which is trained on a specific application, is applied to a similar application. For instance, a model, which is trained on the detection of objects, can to that effect be further trained or extended, so that this can identify corresponding machines or machine types.

In the present case, the model, which is trained on the basis of the time series of the machine or a first machine, is extended with the time series of the further machine or a second machine. The machine can be a first machine of a manufacturer, for instance, and the further machine can be a second machine or a similar machine of the same manufacturer. The trained model may already be stable. This trained model can be extended by the measured values of the further machine. If the temporal sequence of measured values of the further machine are now fed to the already trained model, the transfer learning can be carried out. In this case, the model can be adjusted to the changing measured values or parameters, for instance. If a neural network with a number of concealed layers is used for the model, for instance, the respective weights can be adjusted to the changed parameters. A model which has already been created for the machine can therefore also be used for the further machine by means of transfer learning. This also offers the possibility of providing a reference model for a machine, which can then be adjusted to the specific machine by means of transfer learning.

A model which describes the machine is to be provided with the aid of the method. The method is in particular a computer-implemented method. The machine can essentially be an electric machine. In particular, the machine can be a machine tool, for instance a CNC machine. The machine can therefore be a CNC milling machine, a CNC turning machine or suchlike. Operation of the machine is controlled by means of the control device. This control device can comprise at least one controller. The control device preferably comprises a plurality of controllers or control circuits, for instance. An operating variable of the machine can be controlled by means of the control device. To this end, an actual value for the operating variable can be detected by means of the control device, for instance, and compared with a target value for the operating variable. The operating variable can be regulated to the target value by means of the control device. The operating variable of the machine can be a rotational speed, a rotational direction, a torque, a feed, an electrical voltage, an electrical current or suchlike, for instance.

With a corresponding detection facility or with a sensor, the temporal series or sequence of measured values can now be provided. Here the measured values describe at least one operating variable of the machines. The measured values can also describe a number of operating variables of the machine. Provision can also be made for a number of or different measured values to be detected. In order to provide the temporal series of measured values, a sensor signal can be scanned accordingly by the sensor of the detection facility. These scanned measured values can then be further processed accordingly.

The temporal series of measured values can be fed to a training system. This training system can be used to determine the model for the machine or also for a number of machines. The training system can have a corresponding computing facility, by means of which the model can be created. For this purpose, a corresponding computer program can be executed on the computing facility. In order to determine the model, the untrained model is firstly provided. The untrained model is an artificial neural network. In order to determine the model or to provide the trained model, this model can be trained accordingly. Here the temporal series of measured values is used as training data. After training, the trained model, which describes the controlled operation of the electric machine, can be output.

As mentioned previously, the model is an artificial neural network. This artificial neural network can also be referred to as artificial neural net or as a neural circuit. An artificial neural network is formed by artificial neurons or nodes, which are connected to one another. Here the connections can provide direction connections between two nodes. With the artificial neural network, the respective nodes can be arranged in the respective layers or concealed layers. For instance, the nodes can be arranged one behind the other in a number of layers. The artificial neural network essentially has an input layer and an output layer and concealed layers arranged therebetween. In order to provide the untrained model, the artificial neural network can firstly be constructed. Here the topology of the artificial neural network or the assignment of links to nodes can be provided for the application.

After constructing the artificial neural network, the training phase can take place, in which the artificial neural network is trained. For training the artificial neural network, the training data is fed to this. In the present case, the temporal sequence of measured values and possibly data relating to control theory can be provided to the artificial neural network or the untrained model as training data. During the training of the artificial neural network, new connections can be developed and/or existing connections deleted. Provision can also be made for corresponding weightings or weighting factors of the nodes or neurons to be adjusted. Moreover, nodes can be added and/or removed. Here the training can be carried out as monitored or supervised learning. In this case, the output is predetermined to the neural network. However, provision can also be made for a non-monitored or non-supervised learning to be carried out during the training. In this case the output is not predetermined. Furthermore, the reinforcement learning can be used during the training phase.

The trained model describes the operation of the machine which is controlled by means of the control device. After the training, control parameters or control variables, which describe the control device, can now be derived by means of the trained model or the artificial neural network. These derived control variables can describe a transmission function of the control device, for instance. In particular, the control variables can describe a type of control device or individual controllers of the control device. There is in particular provision here for the manner in which the operating variable of the machine is controlled to be identified by means of the trained model or the artificial neural network on the basis of the temporal course of the measured values. The manner in which the operating variable is influenced by the controller should therefore be identified. In the simplest case, it can therefore be identified, for instance, whether the transmission function of the control device has a proportional transmission behavior, an integrative transmission behavior, a differentiating transmission behavior and/or a temporally delaying transmission behavior. The control behavior of the control device can therefore be derived with the aid of the trained model. Additional information relating to the control device can therefore be obtained easily and nonetheless reliably.

The determination of the derived control variables is preferably carried out on the basis of control theory data, wherein the control theory data describes modes of operation of control devices. The control theory data can describe known methods of control technology. In particular, the control theory data can describe different transmission functions of controllers. This transmission function can describe the ratio of the input variable in relation to the output variable. The temporal series of measured values can describe the output variable. Provision can also be made for the output variable to be derived from the measured values. The control theory data can describe the different known transmission functions, which are typically used in controllers or control devices. As already mentioned, the transmission function can describe proportional behavior, an integrative behavior, a differentiating behavior, a time-delaying behavior, a control with deadtime or corresponding combinations thereof. This control theory data can be fed to the untrained model or the artificial neural network as training data. In the training the temporal courses of the measured values can then be assigned to the corresponding transmission functions. The control theory data can therefore be determined easily and reliably.

In a further embodiment, the artificial neural network, which is trained, has a plurality of concealed layers. In other words, the neural network is what is known as a deep neural network. One such multilayer artificial neural network also comprises a number of concealed layers in the output layer, the output of which is not visible outside of the network. A penetrative learning or deep learning can be enabled with an artificial neural network of this type. The model or the artificial neural network can therefore be trained in a reliable manner so that it describes the operation of the controlled machine.

Furthermore, it is advantageous if the measured values describe different operating states of the machine. The different operating states can describe a change in the rotational speed of the electric machine, for instance. In this case, different operating states can describe the start-up of the machine, a change in the rotational speed, a change in the thrust, the use of different tools or suchlike, for instance. The influence of the control or control device can be examined more accurately by detecting these different operating states. In other words, different operating states can be detected and the control behavior can be determined hereupon. This enables a reliable training of the model.

Provision can also be made for corresponding target values of the control device to be taken into consideration when the model is determined. These target values can be predetermined for instance by a corresponding operation of the machine. Provision can also be made for these target values to be detected accordingly. The respective target values can be taken into consideration or used as training data when the model or artificial neural network is trained. It is therefore possible to deduce how the operating variable of the machine is controlled to the target value by means of the control device. The control variables can then be derived herefrom.

With the present invention, provision is made in particular for further derived control variables, which describe the further control device, to be determined with the aid of the extended trained model. The extended trained model, which was produced by transfer learning on the basis of the trained model, can now be used to derive the control variables of the further control device, by means of which the further machine is controlled. In particular, if the trained model is already available, the extended trained model can be provided with little effort by the transfer learning. The properties of the further control device can then be derived herefrom.

An inventive training system comprises a first interface for receiving a temporal series of measured values of a machine. Furthermore, the training system comprises a computing facility for determining a trained model with the aid of the received measured values. Finally, the training system comprises a second interface for outputting the trained model. The training system can be provided by a corresponding computer, for instance. This training system can be used for data transmission by way of the first interface of the machine or a sensor of the machine, by means of which the measured values are provided. A corresponding computer program can then be carried out on a computing facility of the training system in order to train the model on the basis of the measured values. The inventive method for providing the model can be carried out with the aid of the training system.

An inventive computer program comprises commands, which, when the program is executed by a training system or a computing facility of the training system, trigger this to carry out the inventive method and the advantageous embodiments.

An inventive computer-readable (storage) medium comprises commands, which, when executed by a training system, trigger this to execute the inventive method and the advantageous embodiments thereof.

A further aspect of the invention relates to a method for simulating operation of a machine, in particular a machine tool, wherein operation of the machine is controlled by means of a control device. In this regard, operation of the machine is modeled with a model which is determined by means of an inventive method for providing a model and/or the advantageous embodiments thereof.

For instance, the model can be provided for a specific machine. The model can be used in order to reproduce the operation of this controlled machine. The model can therefore be executed on a corresponding simulation system or a processor or computer, for instance. In this way the controlled operation of the machine can be simulated or modeled. Operation of the machine and in particular a manufacturing method, which is carried out with the machine, can therefore be tested beforehand, for instance. It is therefore not necessary for corresponding attempts to be carried out with the real machine. Damage to workpieces and/or the machine can therefore be prevented. Furthermore, the model can be used for a faulty analysis in the case of the real machine.

In this regard, provision is made in particular for operation of the control device to be emulated by means of the trained model. The function of the control device can therefore be reproduced with the model or with the artificial neural network. In this way it is possible to check how the control device responds to specific input variables. As a result, corresponding settings can be derived or optimized during real operation of the machine.

An inventive simulation system is used to simulate operation of a machine, in particular a machine tool, wherein operation of the machine is controlled by means of a control device. In this case the simulation system is embodied to carry out an inventive method for simulating operation of a machine.

Furthermore, the invention relates to a computer program, comprising commands, which, when the program is executed by a simulation system, trigger this to execute the inventive method for simulating operation of a machine.

A further aspect of the invention relates to a computer-readable (storage) medium, comprising commands, which when executed by a simulation system, trigger this to execute an inventive method for simulating operation of a machine.

With reference to the inventive method for providing a model, preferred embodiments and their advantages presented for a machine apply accordingly to the inventive training system, to the inventive computer program product and to the inventive computer-readable (storage) medium. Furthermore, the preferred embodiments and their advantages presented with respect to the inventive method for simulating operation of an electric machine apply accordingly to the inventive simulation system, the inventive computer program product and to the inventive computer-readable (storage) medium.

Further features of the invention are produced from the claims, the figures and the description of the figures. The features and combinations of features mentioned in the description above and the following features and combinations of features mentioned in the description of the figures and/or shown in the figures alone are usable not only in the respective combination given, but also in other combinations without departing from the scope of the invention.

The invention is now explained in more detail on the basis of preferred exemplary embodiments and with reference to the appended drawings, in which:

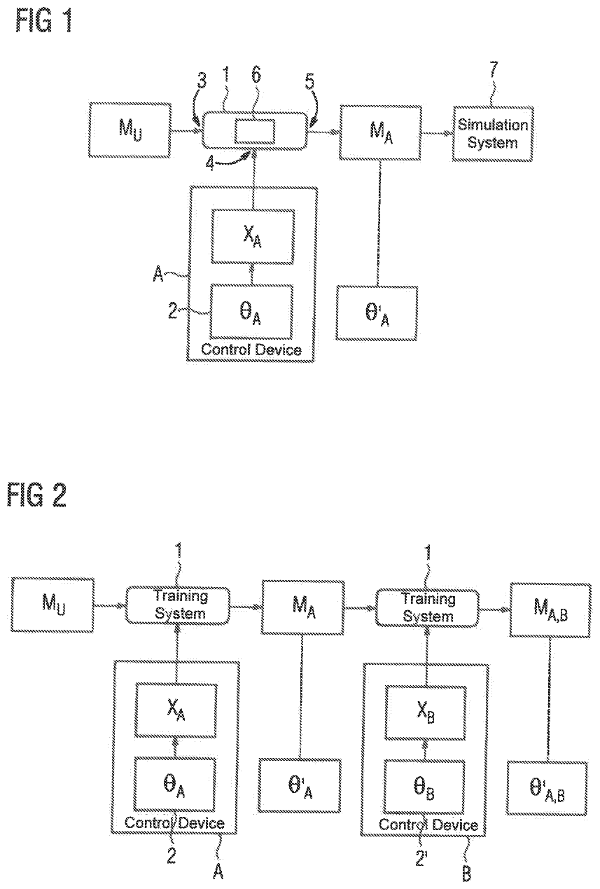

FIG. 1 shows a schematic flow chart of a method for providing a model for a machine, wherein operation of the machine is controlled by means of a control device; and

FIG. 2 shows a schematic flow chart of a method for determining a model for a machine according to a further embodiment.

In the figures, the same or functionally identical elements are provided with the same reference characters.

FIG. 1 shows a schematic flow chart of a method for providing a model M_{A} for a machine A. Machine A can be a machine tool. In particular, machine A is a CNC machine. In this regard operation of the machine A is controlled by means of a control device 2. This control device 2 can comprise a number of controllers or control circuits.

The model M_{A} for the machine A can be determined by means of a training system 1. This training system 1 can be formed by a corresponding computer. The training system 1 here has a corresponding computing facility 6. An untrained model is fed to the training system 1 by way of an interface 3. The untrained model is an artificial neural network, in particular what is known as a deep neural network. A temporal series of measured values X_{A} is fed to the training system 1 by way of an interface 4. These values X_{A} describe operating variables of machine A. For instance, the measured values X_{A} can describe a rotational speed, a direction of rotation, a torque, an electrical voltage, an electrical current or suchlike. Control of the machine A by means of the control device 2 is carried out on the basis of control variables θ_{A}. These control variables θ_{A} are not known, however.

In order to train the untrained model M_{U}, control theory data can moreover be fed hereto. This control theory data describes in particular properties of known control devices 2. For instance, the control theory data can describe different transmission functions, which are used by control devices 2. While the model is being trained, the properties of the control device 2 or the control algorithm of the control device 2 can be approximated or determined with the aid of the temporal course of the measured values X_{A} or the operating variables and the known control theory data.

The trained model M_{A} can then be output by the training system 1 by way of an interface 5. Derived control variables θ′_{A} can then be provided on the basis of the trained model M_{A}. The derived control variables θ′_{A} describe the properties of the control device 2, which have been determined during the training. The trained model M_{A} therefore describes the operation of machine A, which is controlled by means of the control device 2.

FIG. 2 shows a schematic flow chart for determining a model M_{A,B} according to a further embodiment. As explained previously in conjunction with FIG. 1, the untrained model M_{U} is firstly also trained here on the basis of the measured values XA of machine A. The trained model M_{A} can be provided after this training. In this case, what is known as transfer learning is additionally carried out. Here the trained model M_{A} is fed to the training system 1 in a subsequent step.

Furthermore, measured values X_{B} are determined by a further machine B and fed to the training system 1. Here operation of the further machine B is controlled by means of a further control device 2′. The machines A and B can originate from the same manufacturer, for instance, and be different or similar types of machines. The trained model M_{A} can then be extended on the basis of the measured values X_{B} of the further machine B and the extended trained model M_{A,B} can be output by means of the training system 1. This extended trained model M_{A,B} can in turn be used to determine derived control variables θ′_{A′}, θ′_{B}, which have been determined on the basis of the control devices 2, 2′ of the machines A, B.

The trained model M_{A} or the extended trained model M_{A,B} can be used to simulate the operation of the machine A, B. To this end, the model M_{A}, M_{A,B} can be run on a corresponding simulation system 7 or computer. This is shown schematically in FIG. 1. Therefore, operation of the machine A, B, which is controlled by the control device 2, 2′, can therefore be simulated or reproduced. It is therefore possible to obtain information relating to the typically unknown functionality of the complex control device 2, 2′. Overall this allows operation of the machine A, B to be optimized and errors to be avoided.

What is claimed is:

1.-12. (canceled)

13. A method for training a model for an electric machine controlled by a control device, comprising:
receiving a temporal series of measured values that describe an operating variable of the electric machine via a first interface of a training system,
training, based on the received measured values, with a computing facility of the training system an untrained model embodied as an artificial neural network to produce a trained model, and
determining with the trained model derived control variables that describe the control device,
receiving via the first interface of the training system a temporal series of measured values of a further electric machine that is different from the electric machine and controlled by a further control device,
further training the trained model with the computing facility using measured values of the further electric machine to produce a further trained model, and
outputting the trained model and the further trained model via a second interface of the training system.

14. The method of claim 13, wherein the derived control variables are determined based on control theory data that describe modes of operation of the control device and the further control device.

15. The method of claim 13, wherein the artificial neural network comprises a plurality of concealed layers.

16. The method of claim 13, wherein the measured values describe different operating states of the electric machine.

17. The method of claim 13, wherein the further derived control variables are determined with the further trained model.

18. The method of claim 13, wherein reinforcement learning is used during training.

19. The method of claim 13, wherein the measured values of the electric machine and the measured values of the further electric machine describe different operating states of the electric machine.

20. The method of claim 13, further comprising using as training data during training a target value, to which the operating variable can be regulated by the control device.

21. The method of claim 13, further comprising using the trained model for simulating operation of an electric machine.

22. A training system, comprising:
a first interface for receiving a temporal series of measured values of an electric machine and a temporal series of further measured values of a further electric machine which is of a different type than the electric machine, wherein the measured values describe an operating variable of the electric machine,
a computing facility configured to train an untrained model using the received measured values and deriving therefrom a trained model and to further train the trained model to form a further trained model using the further measured values, and
a second interface for outputting the trained model and the further trained model.

23. A computer program product embodied on a computer-readable storage medium and comprising computer commands which, when loaded into a memory of a training system for training a model for an electric machine controlled by a control device and executed by a processor of the training system, cause the training system to execute a method as set forth in claim 13.

24. A method for simulating operation of a first electric machine and a second electric machine, wherein the operation of the first electric machine is controlled by a first control device and the operation of the second electric machine is controlled by a second control device, wherein a first trained model and a second trained model is trained in each case for the first electric machine and for the second electric machine by
receiving a temporal series of measured values that describe an operating variable of the first electric machine via a first interface of a training system,
training, based on the received measured values, with a computing facility of the training system an untrained model embodied as an artificial neural network to produce a first trained model which simulates the operation of the first electric machine, and
determining with the first trained model derived control variables that describe the control device,
receiving via the first interface of the training system a temporal series of measured values of a second electric machine that is different from the first electric machine and controlled by a second control device,
further training the first trained model with the computing facility using measured values of the second electric machine to produce a second trained model which simulates the operation of the second electric machine, and
outputting the first trained model and the second trained model via a second interface of the training system.

25. The method of claim 24, further comprising emulating operation of the first or second control device by using the first trained model and the second trained model, respectively.

26. A simulation system for simulating operation of an electric machine, in particular a machine tool, comprising:
a control device controlling operation of the electric machine, wherein the simulation system is configured to carry out the method as claimed in claim 23.

27. A computer program product embodied on a computer-readable storage medium and comprising computer commands which, when loaded into a memory of a simulation system for simulating operation of an electric machine controlled by a control device and executed by a processor of the simulation system, cause the simulation system to execute the method as set forth in claim 23.
